(19) United States
(12) Patent Application Publication
(10) Pub. No.: US 2026/0156155 A1
(43) Pub. Date: Jun. 4, 2026

(54) ARTIFICIAL INTELLIGENCE TASK AUTOMATION BOT FOR MANAGING SERVER COMPLIANCE

(71) Applicant: BANK OF AMERICA CORPORATION, Charlotte, NC (US)

(72) Inventors: John D. Weber, Lake Saint Louis, MO (US); Naveen Adala, Charlotte, NC (US); Steve Baylon, Virginia Beach, VA (US); Kevin A. Delson, Woodland Hills, CA (US); Kirk A. Hawrysio, Oak Point, TX (US); Rakesh Jain, Murphy, TX (US); Malinda Kieffer, Chillicothe, MO (US); Anne M. Matrone, Staten Island, NY (US); Don L. Maxwell, Bedford, TX (US); Noel Arnaldo Medina, Katy, TX (US); Thomas D. Morris, Middleburg, FL (US); Pramod Muppala, Concord, NC (US); Pankaj Nagpal, Charlotte, NC (US); Owen Nelson, Farmingdale, NY (US); Ajesh Philip, Hyderabad (IN); Robert R. Rosseland, JR., Huntersville, NC (US); Nancy D. Royall, Prosper, TX (US); Tanya A. Wilson, Newark, DE (US)

(73) Assignee: BANK OF AMERICA CORPORATION, Charlotte, NC (US)

(21) Appl. No.: 18/965,455

(22) Filed: Dec. 2, 2024

(51) Int. Cl. H04L 9/40; G06F 40/20

(52) U.S. Cl. CPC H04L 63/20; G06F 40/20

(57) ABSTRACT

Systems, computer program products, and methods are described herein for artificial intelligence task automation bot for managing server compliance. A plurality of Systems of Record (SORs) are accessed, the SORs are scanned for server identification, and based on the server identification, a list of servers is generated; one or more baseline compliance documents are analyzed to determine one or more baseline compliance standards; using the one or more baseline compliance standards, each of the servers in the list of servers, are scanned to identify each of the servers as compliant with each of the baseline compliance standards or non-compliant with at least one of the baseline compliance standards; the list of servers is updated to indicate compliant status or non-compliant status for each of the servers; and for each of the servers identified as non-compliant, a communication is generated and initiated, to a server controlling-entity, of a non-compliance notification.

### TECHNOLOGICAL FIELD

Example embodiments of the present disclosure relate to artificial intelligence-based management of baseline server compliance.

### BACKGROUND

Corporations have policies that provide for baseline compliance standards that all servers must be in compliance with to be operational. Servers not in compliance with these baseline standards may be unsecure in violation of corporate policy and possibly regulatory requirements. Unsecure servers are vulnerable to attack putting data stored on these servers in peril. Traditional systems require manual inputs to analyze baseline compliance documents, determine a compliance status for each server, and remediate servers not in compliance with baseline compliance standards, which presents a challenge to the management of these systems.

Applicant has identified a number of deficiencies and problems associated with artificial intelligence-based management of baseline server compliance. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for artificial intelligence task automation bot for managing server compliance.

The present invention provides for a system for managing baseline server compliance, the system comprising: at least one processing device, at least one non-transitory storage device configured to store one or more Artificial Intelligence (AI) bots, wherein the one or more AI bots, when executed by the at least one processing device, cause the at least one processing device to: access a plurality of Systems of Record (SORs); scan the SORs for server identification and, based on the server identification, generate a list of servers; analyze one or more baseline compliance documents and determine one or more baseline compliance standards; scan, using the one or more baseline compliance standards, each of the servers in the list of servers, to identify each of the servers as compliant with the one or more baseline compliance standards or non-compliant with at least one of the one or more baseline compliance standards; as a result of the scanning of each of the servers in the list of servers, update the list of servers to indicate compliant status or non-compliant status for each of the servers; and for each of the one or more servers identified as non-compliant, generate and initiate communication, to a server controlling-entity, of a non-compliance notification.

The one or more AI bots further cause the at least one processing device to: continually access a plurality of SORs, scan the SORs for server identification and, based on the server identification, revise the list of servers, wherein revising includes adding and deleting servers from the list of servers.

The one or more AI bots further cause the at least one processing device to: in response to revising the list of servers, scan, using the one or more baseline compliance standards, at least servers added to the list of servers, to identify one or more servers from amongst the servers of the list of servers that are non-compliant with at least one of the one or more baseline compliance standards.

The one or more AI bots further cause the at least one processing device to use at least one of natural language processing (NLP) and machine learning to analyze the baseline compliance documents and determine the one or more baseline compliance standards.

The one or more AI bots further cause the at least one processing device to determine a remediation process for each server with a non-compliant status.

The one or more AI bots further cause the at least one processing device to: implement the remediation process to execute one or more changes to the at least one configuration of each non-compliant server so that each non-compliant server is compliant with each of the one or more baseline compliance standards, and as a result of implementing the remediation process, update the list of servers to indicate compliant status for each of the servers that have undergone the remediation process.

The one or more AI bots further cause the at least one processing device to: for each of the one or more servers that have undergone the remediation process, generate and initiate communication of a compliance notification, to the server controlling-entity, that indicates compliance and the remediation process for each of the identified servers.

The one or more AI bots further cause the at least one processing device to use generative AI to determine the remediation process for each of the servers with a non-compliant status.

The one or more AI bots comprise (i) a first AI bot that causes the at least one processing device to, in response to determining the one or more baseline compliance standards, generate an input file comprising the one or more baseline compliance standards and (ii) a second AI bot that causes the at least one processing device to analyze the input file prior to implementing any required changes to the one or more non-compliant servers, wherein the input file serves as an input for the scanning of each server.

The first AI bot further causes the at least one processing device to: continually analyze the one or more baseline compliance documents and determine one or more changes to the baseline compliance standards; in response to determining the one or more changes to the baseline compliance standards, update the input file with the determined changes.

A computer program product for managing baseline server compliance, the computer program product comprising: at least one processing device, at least one non-transitory storage device configured to store one or more AI bots, wherein the one or more AI bots, when executed by the at least one processing device, cause the at least one processing device to: access a plurality of SORs, scan the SORs for server identification and, based on the server identification, generate a list of servers; analyze one or more baseline compliance documents and determine one or more baseline compliance standards; scan, using the one or more baseline compliance standards, each of the servers in the list of servers, to identify each of the servers as compliant with the one or more baseline compliance standards or non-compliant with at least one of the one or more baseline compliance standards; as a result of the scanning of each of the servers in the list of servers, update the list of servers to indicate compliant status or non-compliant status for each of the servers; and for each of the one or more servers identified as non-compliant, generate and initiate communication, to a server controlling-entity, of a non-compliance notification.

A method for managing baseline server compliance, the method comprising: access a plurality of SORs, scan the SORs for server identification and, based on the server identification, generate a list of servers; analyze one or more baseline compliance documents and determine one or more baseline compliance standards; scan, using the one or more baseline compliance standards, each of the servers in the list of servers, to identify each of the servers as compliant with the one or more baseline compliance standards or non-compliant with at least one of the one or more baseline compliance standards; as a result of the scanning of each of the servers in the list of servers, update the list of servers to indicate compliant status or non-compliant status for each of the servers; and for each of the one or more servers identified as non-compliant, generate and initiate communication, to a server controlling-entity, of a non-compliance notification.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for artificial intelligence task automation bot for managing server compliance, in accordance with an embodiment of the disclosure.

FIG. 2 illustrates a process flow for artificial intelligence task automation bot for managing server compliance, in accordance with an embodiment of the disclosure.

FIG. 3 illustrates an exemplary AI subsystem architecture, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction,” “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (e.g., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points and the like. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

Corporations have baseline compliance standards that all servers must be in compliance with to be operational. Servers not in compliance with these baseline standards may be unsecure in violation of corporate policy and possibly regulatory requirements. Unsecure servers are vulnerable to attack putting data stored on these servers in peril.

Current systems for managing server compliance with baseline standards require manual operation. A user analyzes compliance documents, determines the compliance status of each server, and notifies a server controlling-entity of the compliance status of each server. This system poses efficiency challenges as well as challenges to managing the number of severs a corporation may own.

The claimed invention uses one or more AI bots to manage server compliance with the baseline compliance standards. The one or more AI bots analyze one or more baseline compliance documents and determine one or more baseline compliance standards, identify each server as compliant with the one or more baseline compliance standards or non-compliant with at least one of the one or more baseline compliance standards, update the list of servers to indicate compliant status or non-compliant status for each of the servers; and for each of the one or more servers identified as non-compliant, generate and initiate communication, to a server controlling-entity, of a non-compliance notification.

Accordingly, the present disclosure provides for a system for managing baseline server compliance. One or more AI bots access a plurality of SORs, scan the SORs for server identification, and based on the server identification, generate a list of servers; analyze one or more baseline compliance documents, and determine one or more baseline compliance standards; scan, using the one or more baseline compliance standards, each of the servers in the list of servers, to identify each of the servers as compliant with the one or more baseline compliance standards or non-compliant with at least one of the one or more baseline compliance standards; as a result of the scanning of each of the servers in the list of servers, update the list of servers to indicate compliant status or non-compliant status for each of the servers, and for each of the one or more servers identified as non-compliant, generate and initiate communication, to a server controlling-entity, of a non-compliance notification.

What is more, the present disclosure provides a technical solution to a technical problem. As described herein, the technical problem includes the manual analysis of baseline compliance documents and compliant or non-compliant status identification for each server in a list of servers. The technical solution presented herein allows for use of task automation AI bots for managing server compliance with baseline standards, improving the efficiency of the system. In particular, the use of AI to automate the analysis of baseline compliance standards and the remediation of non-compliant servers is an improvement over existing solutions, wherein analysis and remediation steps require manual input, (i) with fewer steps to achieve the solution, thus reducing the amount of computing resources, such as processing resources, storage resources, network resources, and/or the like, that are being used, (ii) providing a more accurate solution to the problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

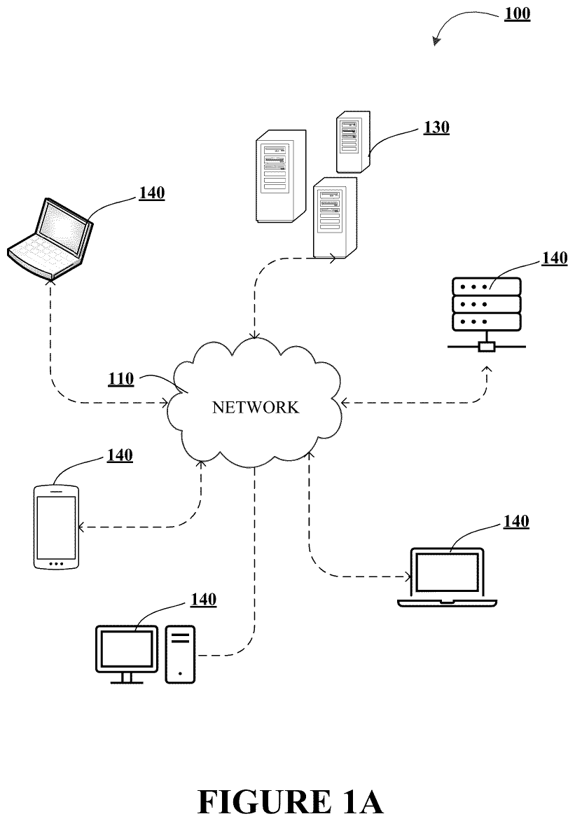

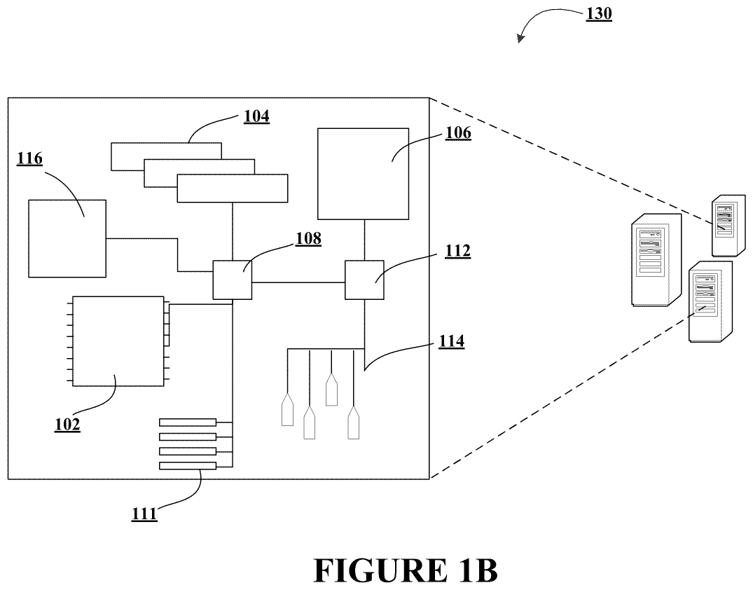

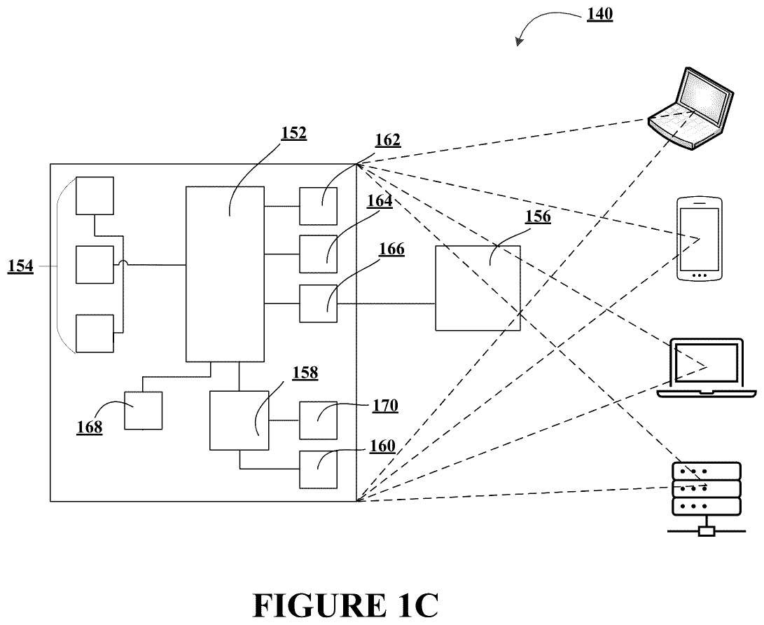

FIGS. 1A-1C illustrate technical components of an exemplary distributed computing environment for artificial intelligence-based management of baseline server compliance 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random-access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, and the like.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

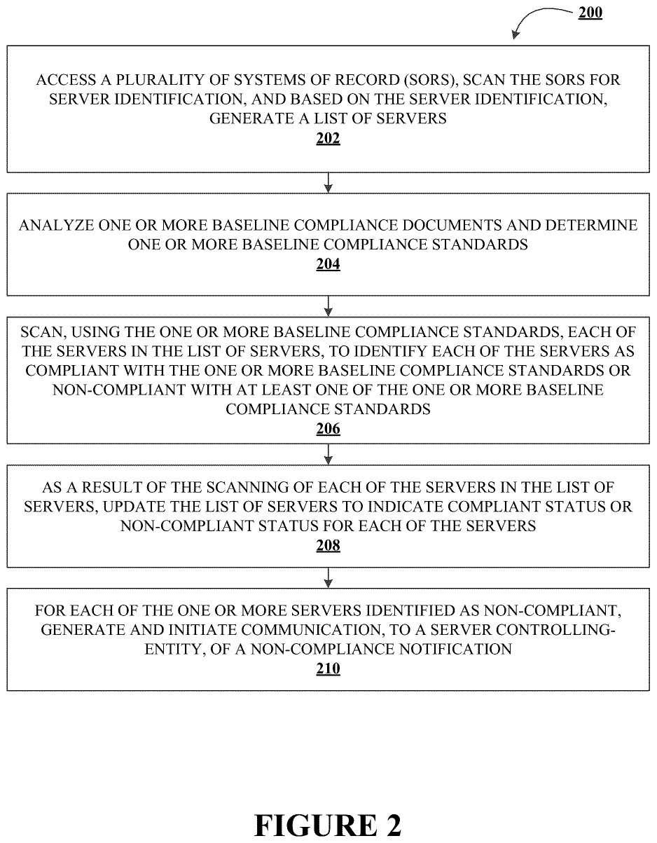

FIG. 2 illustrates a flow diagram of a method 200 for the management of baseline server compliance. At Event 202, a plurality of SORs is accessed. The SORs are scanned for server identification, and based on the server identification, a list of servers is generated. In some embodiments, a plurality of SORs is continually accessed and scanned for server identification, wherein one or more AI bots access and scan the plurality of SORs for server identification. Based on the server identification, the list of servers is continually revised wherein revising includes adding and deleting servers from the list of servers.

At Event 204, one or more baseline compliance documents are analyzed, and one or more baseline compliance standards are determined. In some embodiments, the one or more AI bots use at least one of natural language processing (NLP) and machine learning to analyze the baseline compliance documents and determine the one or more baseline compliance standards. In some embodiments, the one or more baseline compliance documents comprise baseline compliance standards governing server security settings, access controls, and the like. In some other embodiments, a first AI bot analyzes the baseline compliance documents and generates an input file which comprises a comprehensive template of the baseline compliance standards that each server of the list of servers must be in compliance with. The template includes but is not limited to baseline compliance standards for server security settings, access controls, data protection, and the like. In some other embodiments, the first AI bot scans the baseline compliance documents to determine whether any changes to the baseline compliance documents have occurred from a first time to a second time. If there are any changes to the baseline compliance documents, the first AI bot updates the input file to reflect any such changes. In some embodiments, a team of users may approve or disapprove of the analysis of the baseline compliance documents by the one or more AI bots.

In some embodiments, baseline compliance standards govern one or more server configurations, controls, and the like, including the operating system configuration of the server, security settings, access controls, and data protection. For example, baseline compliance standards governing the configuration of the operating system of the server require the operating system to be updated with the latest version of one or more security patches. In another embodiment, the baseline compliance standards governing the security settings of the server require that the proper firewall configurations be installed and may also require the installation of antivirus and anti-malware programs. For example, it is required that the server hosting a website or application have the proper security settings and be up-to-date with all security patches, including a website or application wherein a user has access to one or more resource accounts and/or conducts resource transfers. Further, security settings may include enabling disk encryption for sensitive data. In some other embodiments, an organization may have password policies including requirements for the composition and/or complexity of the password (e.g., requiring at least one capital letter, at least one number, and the like) and the frequency with which the password is required to be changed (e.g., every 6 months and the like).

In some other embodiments, baseline compliance standards govern software and application compliance. In this embodiment, baseline compliance standards may require that software installed on the server complies with any and all licensing agreements (e.g., user rights, restrictions on use of the software, the duration of the license, and the like). Further, baseline compliance may mandate applying software updates and patches at a determined frequency. In another embodiment, the baseline compliance standards govern access controls. In this embodiment, access to the server is restricted to a subset of users (e.g., role-based access controls). The subset of users granted permission to access the server is determined based on the role assigned to the user (e.g., Administrator, User, Manager, and the like). In this example, users may also need permission to perform specific actions on the server (e.g., read, write, delete, and the like). Further, multi-factor authentication (MFA) may be used to restrict access to the server by requiring a secondary level of permission (i.e., a unique code sent to the device of the user and the like). In some further embodiments, access and usage logs are maintained for auditing purposes. In some embodiments, baseline compliance standards govern data protection, including backing-up data and encrypting sensitive data to prevent unauthorized access to the data. In this embodiment, data encryption can protect both data transmitted across a network (e.g., data in transit) as well as data stored on a server (i.e., data at rest). In some further embodiments, the baseline compliance standards align with regulatory standards. For example, the baseline compliance standards may adhere to regulatory standards as set forth by the health insurance portability and accountability act (HIPAA), the general data protection regulation (GDPR), the payment card industry data security standard (PCI DSS) and/or the like. In these examples, the organization must maintain records of compliance with the appropriate baseline standards for auditing purposes.

At Event 206, using the one or more baseline compliance standards, each of the servers in the list of servers are scanned to identify each of the servers as compliant with the one or more baseline compliance standards or non-compliant with at least one of the one or more baseline compliance standards. In some embodiments, using the one or more baseline compliance standards, the list of servers is scanned in response to the revising of the list of servers to identify servers not in compliance with at least one of the baseline compliance standards. In this embodiment, at least the servers added to the list of servers are scanned. In some other embodiments, based on an analysis of the input file generated by the first AI bot, a second AI bot scans the list of servers to identify servers that are in compliance with each baseline compliance standard and servers that are non-compliant with at least one baseline compliance standard. In this embodiment, the second AI bot uses the template set forth in the input file generated by the first AI bot to determine whether each server in the list of servers is in compliance with each baseline compliance standard. For example, the second AI bot checks each server for compliance with each baseline standard such as whether the server complies with the password policies of the organization (e.g., complies with the complexity and frequency standards and the like) and the like. In some embodiments, a non-compliant server may comply with some but not all baseline compliance standards (e.g., complies with the data encryption baseline standard but does not have the latest security patch installed and the like). In some other embodiments, the baseline compliance standard has one or more features. For example, checking a server for one or more unnecessary applications requires analysis of multiple features, including the usage of the application, the resource consumption of the application, and the like. In some embodiments, the scan of the list of servers is scheduled by the AI bot. In some embodiments, the scan is scheduled by a group of one or more users and is performed at a set frequency (e.g., every week, every month, and the like).

At Event 208, as a result of the scanning of each of the servers in the list of servers, the list of servers is updated to indicate a status of compliant or non-compliant for each of the servers. In some embodiments, one or more servers in the list of servers have a non-compliant status at a first time, wherein the server is not in compliance with at least one baseline compliance standard. At a second time, the remediation process is implemented, wherein the remediation process executes one or more changes to the servers with a non-compliant status to bring the servers into compliance with each of the one or more baseline compliance standards. At the second time, the one or more servers with a non-compliance status are now compliant with each of the one or more baseline compliance standards. As a result of implementing the remediation process, the list of servers is updated to indicate the compliance status for each of the servers that have undergone the remediation process. The list of servers is updated to reflect that the non-compliant servers at the first time are now compliant at the second time. In this embodiment, the status of the non-compliant servers changes from non-compliant to compliant, and these compliant servers will not undergo a further remediation process. In some embodiments, for servers with a compliance status at the first time, the status of the one or more servers remains unchanged.

At Event 210, for each of the one or more servers identified as non-compliant, a communication is generated and initiated, to a server-controlling-entity, of a non-compliance notification. In some embodiments, for each of the one or more servers that have undergone the remediation process, a communication of a compliance notification is generated and initiated to the server controlling-entity that indicates compliance and the remediation process for each of the identified servers. In some embodiments, the AI bot will prepare and send such notifications, including notifications of the non-compliant status of each non-compliant server in the list of servers, the remediation process for each server with a non-compliant status as determined by the AI bot, and the like. In this embodiment, a group of one or more users are notified. In some other embodiments, the group of users may provide manual inputs to the system based on the one or more notifications received. For example, the group of users may determine that the AI bot misread at least one of the one or more baseline compliance documents, resulting in an incorrect compliance status for one or more servers. In this embodiment, the group of users will manually input the correct compliance status of the one or more servers with an incorrect compliance status, based on a correct reading of the one or more baseline compliance documents. In some other embodiments, the group of users may determine that the remediation process determined by the AI bot has one or more defects, and the group of users may manually input a remediation process for the one or more servers with a non-compliance status.

A remediation process is determined for each server identified as non-compliant, wherein the remediation process is configured to execute one or more changes to the at least one configuration of each non-compliant server so that each identified server is compliant with each of the one or more baseline compliance standards. It should be noted that the remediation process that is determined will vary from server to server depending at least on the non-compliance. In some embodiments, a remediation process comprises identifying each of the baseline compliance standards the non-compliant server is not in compliance with and determining a process for bringing the non-compliant server into compliance with each of the identified baseline compliance standards. For each identified server, the AI bot compares the present state of the non-compliant server to the baseline compliance standard and determines a process for bringing the non-compliant server into compliance with each and every baseline compliance standard. For example, for a server that is not in compliance with baseline security protocols, the remediation process will implement changes to the security protocols of the non-compliant server such that the server is compliant with the security protocols as detailed in the input file (e.g., The AI bot installs the up-to-date security patch to bring the server into compliance with the baseline compliance standard). Some servers may require changes to some but not all configurations of the server. It should be noted that the remediation process that is determined will vary from server to server depending at least on the various non-compliant standards.

In some embodiments, determining remediation process comprises determining one or more tasks that need to be performed to bring a server into compliance with each baseline compliance standard for which it is non-compliant. In some other embodiments, the one or more tasks include restarting the server, generating new files, modifying code, and the like. In some embodiments, determining the remediation process includes determining the order/sequence in which the tasks are required to be performed in. For example, a remediation process comprises a first task and a second task. In this example, the first task must be performed before the second task in order to perform the remediation process for a single compliance standard. In this example, a first task must be performed first because if, for instance, the second task is performed first, the remediation process would not achieve the required changes to the server and would fail to bring the server into compliance with the baseline compliance standard. The specific order varies by the baseline compliance standard. For example, a restart task may be required for specific updates to security settings and controls to take effect. In another example, the remediation process may comprise the task of modifying existing code. In these examples, the remediation process may require the ordered tasks of first modifying existing code (i.e., modifying the code for the security setting, control, and/or the like) and second, restarting the server. The tasks are performed in this order so that the security settings, controls, and the like may be updated in compliance with the baseline compliance standard. In another example, bringing a server into compliance with a baseline compliance standard may involve modifications to role-based access controls. In this example, the remediation process may require the ordered tasks of first modifying the existing code (i.e., modifications to code for the role-based access controls and the like) and second, a restart of the server.

In some embodiments the second AI bot determines the specific order of the remediation tasks based on the specifications of each baseline compliance standard and knowledge of the one or more tasks required to bring the server into compliance with the baseline compliance standard. The second AI bot analyzes the input file generated by the first AI bot and learns the baseline compliance standards. Based on the analysis of the input file and the state of the server with respect to one or more baseline compliance standards at the time of the scan, the second AI bot determines the remediation process for each non-compliant server which involves determining a set of one or more tasks that are required to bring the server into compliance with each baseline compliance standard. For example, if a server is non-compliant with more than one baseline compliance standard, a remediation process comprises one or more subsets of a remediation process, wherein a subset of the remediation process is a set of tasks for bringing the server into compliance with a single baseline compliance standard. For example, the remediation process may comprise a subset of tasks to bring the server into compliance with the baseline standard for security protocols and another set of tasks for bringing the server into compliance with one or more regulatory requirements. The second AI bot further determines whether a specific order of the one or more tasks is required. In some embodiments, a specific order is required when the outcome of the remediation process depends on the order of the tasks (e.g., updating the security settings of the server depends on restarting the server subsequent to modification of the code). In this embodiment, the second AI bot performs the remediation tasks in the specified order. In some embodiments, a specific order is not required for the remediation process to bring the server into compliance with the baseline compliance standard. In this embodiment, a specific order is not required either because the remediation process or subset of the remediation process only involves a single task or the order of the tasks does not affect the outcome of the remediation process.

In some other embodiments, the system will send out a notification to the team of users for approval of the remediation plan. In this embodiment, the notification will detail the remediation plan to bring each identified server into compliance with each and every baseline compliance standard. The users will approve or not approve the remediation plan, in whole or in part. For remediation plans not approved, the team of users may manually implement a remediation plan or portion of a remediation plan. In some further embodiments, generative AI is used to determine the remediation plan. In some further embodiments, one or more users will schedule the date and/or time for implementation of the remediation process.

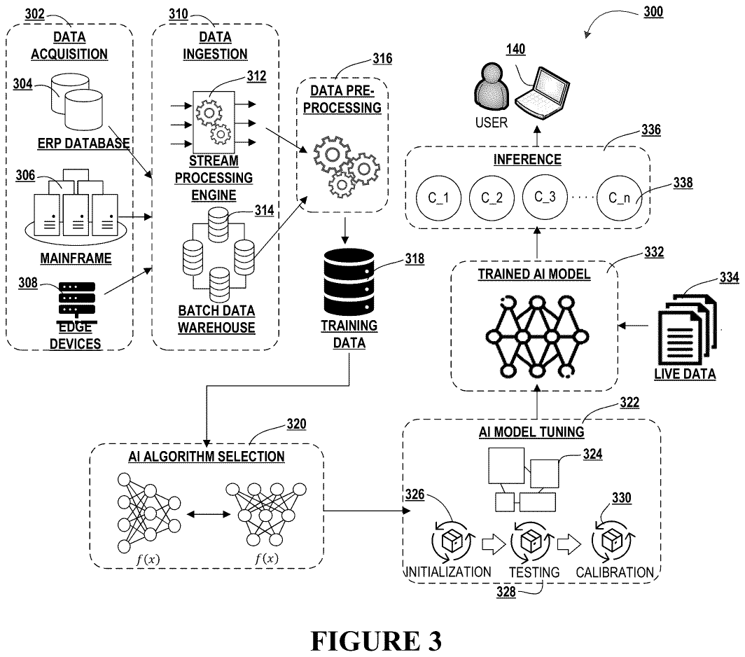

FIG. 3 illustrates an exemplary artificial intelligence (AI) subsystem architecture 300, in accordance with an embodiment of the invention. The artificial intelligence subsystem 300 may include a data acquisition engine 302, data ingestion engine 310, data pre-processing engine 316, AI model tuning engine 322, and inference engine 336.

The data acquisition engine 302 may identify various internal and/or external data sources to generate, test, and/or integrate new features for training the artificial intelligence model 324. These internal and/or external data sources 304, 306, and 308 may be initial locations where the data originates or where physical information is first digitized. The data acquisition engine 302 may identify the location of the data and describe connection characteristics for access and retrieval of data. In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In artificial intelligence, the quality of data and the useful information that can be derived therefrom directly affects the ability of the artificial intelligence model 324 to learn. The data pre-processing engine 316 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 318 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI model tuning engine 322 may be used to train an artificial intelligence model 324 using the training data 318 to make predictions or decisions without explicitly being programmed to do so. The artificial intelligence model 324 represents what was learned by the selected artificial intelligence algorithm 320 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, and the like.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, and the like.), an instance-based method (e.g., k-nearest neighbor, learning vector quantization, self-organizing map, and the like.), a regularization method (e.g., ridge regression, least absolute shrinkage and selection operator, elastic net, and the like.), a decision tree learning method (e.g., classification and regression tree, iterative dichotomiser 3, C4.5, chi-squared automatic interaction detection, decision stump, random forest, multivariate adaptive regression splines, gradient boosting machines, and the like.), a Bayesian method (e.g., naïve Bayes, averaged one-dependence estimators, Bayesian belief network, and the like.), a kernel method (e.g., a support vector machine, a radial basis function, and the like.), a clustering method (e.g., k-means clustering, expectation maximization, and the like.), an associated rule learning algorithm (e.g., an Apriori algorithm, an Eclat algorithm, and the like.), an artificial neural network model (e.g., a Perceptron method, a back-propagation method, a Hopfield network method, a self-organizing map method, a learning vector quantization method, and the like.), a deep learning algorithm (e.g., a restricted Boltzmann machine, a deep belief network method, a convolution network method, a stacked auto-encoder method, and the like.), a dimensionality reduction method (e.g., principal component analysis, partial least squares regression, Sammon mapping, multidimensional scaling, projection pursuit, and the like.), an ensemble method (e.g., boosting, bootstrapped aggregation, AdaBoost, stacked generalization, gradient boosting machine method, random forest method, and the like.), and/or the like.

To tune the artificial intelligence model, the AI model tuning engine 322 may repeatedly execute cycles of experimentation 326, testing 328, and tuning 330 to optimize the performance of the artificial intelligence algorithm 320 and refine the results in preparation for deployment of those results for consumption or decision making. To this end, the AI model tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained artificial intelligence model 332 is one whose hyperparameters are tuned and model accuracy maximized.

The trained artificial intelligence model 332, similar to any other software application output, can be persisted to storage, file, memory, or application, or looped back into the processing component to be reprocessed. More often, the trained artificial intelligence model 332 is deployed into an existing production environment to make practical business decisions based on live data 334. To this end, the artificial intelligence subsystem 300 uses the inference engine 336 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 338) live data 334 based on how similar they are to one another to solve exploratory challenges where little is known about the data, provide a description or label (e.g., C_1, C_2 . . . C_n 338) to live data 334, such as in classification, and/or the like. These categorized outputs, groups (clusters), or labels are then presented to the user input system 130. In still other cases, artificial intelligence models that perform regression techniques may use live data 334 to predict or forecast continuous outcomes.

It will be understood that the embodiment of the artificial intelligence subsystem 300 illustrated in FIG. 3 is exemplary and that other embodiments may vary. As another example, in some embodiments, the artificial intelligence subsystem 300 may include more, fewer, or different components.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for managing baseline server compliance, the system comprising:
at least one processing device;
at least one non-transitory storage device configured to store one or more Artificial Intelligence (AI) bots, wherein the one or more AI bots, when executed by the at least one processing device, cause the at least one processing device to:
access a plurality of Systems of Record (SORs), scan the SORs for server identification, and based on the server identification, generate a list of servers;
analyze one or more baseline compliance documents and determine one or more baseline compliance standards;
scan, using the one or more baseline compliance standards, each of the servers in the list of servers, to identify each of the servers as compliant with the one or more baseline compliance standards or non-compliant with at least one of the one or more baseline compliance standards;
as a result of the scanning of each of the servers in the list of servers, update the list of servers to indicate compliant status or non-compliant status for each of the servers; and
for each of the one or more servers identified as non-compliant, generate and initiate communication, to a server controlling-entity, of a non-compliance notification.

2. The system of claim 1, wherein the one or more AI bots further cause the at least one processing device to:
continually access a plurality of SORs, scan the SORs for server identification, and based on the server identification, revise the list of servers, wherein revising includes adding and deleting servers from the list of servers.

3. The system of claim 2, wherein the one or more AI bots further cause the at least one processing device to:
in response to revising the list of servers, scan, using the one or more baseline compliance standards, at least servers added to the list of servers, to identify one or more servers from amongst the servers of the list of servers that are non-compliant with at least one of the one or more baseline compliance standards.

4. The system of claim 1, wherein the one or more AI bots further cause the at least one processing device to use at least one of natural language processing (NLP) and machine learning to analyze the baseline compliance documents and determine the one or more baseline compliance standards.

5. The system of claim 1, wherein the one or more AI bots further cause the at least one processing device to determine a remediation process for each server identified as non-compliant.

6. The system of claim 5, wherein the one or more AI bots further cause the at least one processing device to:
implement the remediation process to execute one or more changes to the at least one configuration of each non-compliant server so that each identified server is compliant with each of the one or more baseline compliance standards; and
as a result of implementing the remediation process, update the list of servers to indicate compliant status for each of the servers that have undergone the remediation process.

7. The system of claim 6, wherein the one or more AI bots further cause the at least one processing device to:
for each of the one or more servers that have undergone the remediation process, generate and initiate communication of a compliance notification, to the server controlling-entity, that indicates compliance and the remediation process for each of the identified servers.

8. The system of claim 5, wherein the one or more AI bots further cause the at least one processing device to use generative AI to determine the remediation process for each of the identified servers.

9. The system of claim 1, wherein the one or more AI bots comprise (i) a first AI bot that causes the at least one processing device to, in response to determining the one or more baseline compliance standards, generate an input file comprising the one or more baseline compliance standards and (ii) a second AI bot that causes the at least one processing device to analyze the input file prior to implementing any required changes to the one or more identified servers, wherein the input file serves as an input for the scanning of each server.

10. The system of claim 9, wherein the first AI bot further causes the at least one processing device to:
continually analyze the one or more baseline compliance documents and determine one or more changes to the baseline compliance standards; and
in response to determining the one or more changes to the baseline compliance standards, update the input file with the determined changes.

11. A computer program product for managing baseline server compliance, the system comprising:
at least one processing device;
at least one non-transitory storage device configured to store one or more Artificial Intelligence (AI) bots, wherein the one or more AI bots, when executed by the at least one processing device, cause the at least one processing device to:
access a plurality of Systems of Record (SORs), scan the SORs for server identification, and based on the server identification, generate a list of servers;
analyze one or more baseline compliance documents and determine one or more baseline compliance standards;
scan, using the one or more baseline compliance standards, each of the servers in the list of servers, to identify each of the servers as compliant with the one or more baseline compliance standards or non-compliant with at least one of the one or more baseline compliance standards;
as a result of the scanning of each of the servers in the list of servers, update the list of servers to indicate compliant status or non-compliant status for each of the servers; and
for each of the one or more servers identified as non-compliant, generate and initiate communication, to a server controlling-entity, of a non-compliance notification.

12. The computer program product of claim 11, wherein the one or more AI bots further cause the at least one processing device to:
continually access a plurality of SORs, scan the SORs for server identification, and based on the server identification, revise the list of servers, wherein revising includes adding and deleting servers from the list of servers.

13. The computer program product of claim 12, wherein the one or more AI bots further cause the at least one processing device to:
in response to revising the list of servers, scan, using the one or more baseline compliance standards, at least servers added to the list of servers, to identify one or more servers from amongst the servers of the list of servers that are non-compliant with at least one of the one or more baseline compliance standards.

14. The computer program product of claim 11, wherein the one or more AI bots further cause the at least one processing device to determine a remediation process for each server identified as non-compliant.

15. The computer program product of claim 14, wherein the one or more AI bots further cause the at least one processing device to:
implement the remediation process to execute one or more changes to the at least one configuration of each non-compliant server so that each identified server is compliant with each of the one or more baseline compliance standards; and
as a result of implementing the remediation process, update the list of servers to indicate compliant status for each of the servers that have undergone the remediation process.

16. The computer program product of claim 11, wherein the one or more AI bots comprise (i) a first AI bot that causes the at least one processing device to, in response to determining the one or more baseline compliance standards, generate an input file comprising the one or more baseline compliance standards and (ii) a second AI bot that causes the at least one processing device to analyze the input file prior to implementing any required changes to the one or more identified servers, wherein the input file serves as an input for the scanning of each server.

17. A method for managing baseline server compliance, the system comprising:
accessing a plurality of Systems of Record (SORs), scanning the SORs for server identification, and based on the server identification, generating a list of servers;
analyzing one or more baseline compliance documents and determining one or more baseline compliance standards;
scanning, using the one or more baseline compliance standards, each of the servers in the list of servers, to identify each of the servers as compliant with the one or more baseline compliance standards or non-compliant with at least one of the one or more baseline compliance standards;
as a result of the scanning of each of the servers in the list of servers, updating the list of servers to indicate compliant status or non-compliant status for each of the servers; and
for each of the one or more servers identified as non-compliant, generating and initiating communication, to a server controlling-entity, of a non-compliance notification.

18. The method of claim 17, wherein the method further comprises:
continually accessing a plurality of SORs, scanning the SORs for server identification and, based on the server identification, revising the list of servers, wherein revising includes adding and deleting servers from the list of servers.

19. The method of claim 18, wherein the method further comprises:
in response to revising the list of servers, scanning, using the one or more baseline compliance standards, at least servers added to the list of servers, to identify one or more servers from amongst the servers of the list of servers that are non-compliant with at least one of the one or more baseline compliance standards.

20. The method of claim 17, wherein the method further comprises determining a remediation process for each server identified as non-compliant.
